(19) United States
(12) Patent Application Publication
(10) Pub. No.: US 2007/0294128 A1
(43) Pub. Date: Dec. 20, 2007

(54) AUTOMATED ONLINE METHODOLOGY FOR FORECASTING AND ANTICIPATING ALTERNATIVE FUTURES DEVELOPMENTS

(76) Inventor: Dan J. WEDEMEYER, Honolulu, HI (US)

Correspondence Address: LEIGHTON K. CHONG;PATENT ATTORNEY, 133 KAAI STREET, HONOLULU, HI, 96821, US

(21) Appl. No.: 11/757,311

(22) Filed: Jun. 1, 2007

Related U.S. Application Data
(60) Provisional application No. 60/803,842, filed on Jun. 2, 2006.

(51) Int. Cl. G06F 17/30

(52) U.S. Cl. 705/10

(57) ABSTRACT

A futures forecasting method employs an online Futures Forecasting Engine (FFE) which gathers forecasted trends and events data from invited participants, and rates, categorizes, and sorts the participants input to produce a study forecast. The method has four main stages: (1) Swarm stage which establishes the participants in a study; (2) Alpha/Beta stage which solicits forecasts of trends and events from participants and establishes which trends and events meet parameters to be utilized in the study; (3) Delphi stage which gathers participants' estimates of event probabilities and trend levels over time, and further gathers participants' revised estimates of rated event probabilities and trend levels; and (4) Output stage in which all desired statistics are calculated and a final report is prepared.

This U.S. patent application claims the priority benefit of U.S. Provisional Application No. 60/803,842, of the same inventor and same title, filed on Jun. 2, 2006.

### TECHNICAL FIELD

This U.S. patent application is directed to an invention of an online methodology for futures forecasting of the probabilities of event occurrences and levels of trends. This methodology contains multiple methods for creating and prioritizing future developments, harnessing expert opinion via a Futures Forecasting Engine, and processing, reporting and interpreting the created data. It is best implemented as an Internet-based application (i.e. the World Wide Web) and is scalable from local to global in application. It is also automated, topic-generic and scalable in years.

### BACKGROUND OF INVENTION

Over the last several decades, it has become apparent that we have entered policy-making and planning environments of increasing complexities, where rapid innovation will continue to heighten policy and planning uncertainty for everyone as technological, economic, political, environmental and social trajectories become more difficult to anticipate. In order to minimize risks and maximize opportunities, policymakers and planners will have to embrace and anticipate rapid change. These factors heighten uncertainty about the future and the impact of policy and planning decisions. Systematically reducing future uncertainties presents high returns (profits or public goods).

Despite needs for long-term planning, problems or opportunities outside of a five-year timeframe are seldom detected and addressed. Even when they are identified, they may not be sufficiently defined or prioritized to generate the level of attention or financial support necessary to ameliorate or embrace them. Or, they may be put aside pending the emergence of more data or to deal with other conditions that are deemed more urgent or seemingly more profitable or threatening in the short term.

While uncertain, it is important to recognize that the future does emerge from past trends and current events. The vast majority of problems provide some form of advance warning years or decades in advance. By scanning for the “weak signals” of the impending future, decision-makers “can identify key opportunities and threats . . . in time to shape them to [their] advantage. This necessarily involves working with incomplete information—though it is the best available” (Renfro, 1994).

Communication, information and control are the foundations of cybernetics. The cybernetics model arose from information and communication theory (e.g. Shannon and Weaver, 1949) and seeks to identify the abstract principles and organization in biological or machine systems. Cybernetic systems are characterized by feedback loops, where information about the state of the system is compared with goals and actions (positive or negative) which are then cycled back into the system. Traditional cybernetic models work well in less dynamic situations. Past environments could be characterized as being relatively slow-changing, predominantly non-turbulent and offering moderately low risk. In the slowly changing environments of the past, waiting for feedback and subsequently applying control mechanisms for change was an effective strategy. This model cannot be employed any longer.

Emerging environments are often turbulent. Today, and increasingly in the future, we cannot afford to make decisions with a “rear-view mirror” mentality. Systematically generated long-term (alternative) views are needed to anticipate emerging problems while there is still adequate lead-time to analyze the situation and formulate strategies for problem reduction.

Accelerating rates of change and added layers and increasing complexities make the task of anticipating alternatives futures difficult. Nonetheless, anticipating key developments is central to medium and long-term survival. Alternative, “if-then”, “feed-forward” conditions and strategies have to be anticipated. Having done so, they can be combined with associated actions with high returns on investments (ROI), e.g., economic returns, research and development, inventions, elections, and environmental management. This affords adequate lead-time to maximize the possibilities of successful decision making.

FIG. 1 illustrates the traditional cybernetic model. Contrast this with an adapted, feed-forward model (see FIG. 2), which incorporates the notion of anticipatory information in the information and control loop. In this proposed feed-forward cybernetic approach, the “System” represents the complete environment, including social, economic, political, technical and environmental components. “Goals” represent the desired outcome of planning and policy choices. “Actions” are those steps taken to bring the System and Goals into closer alignment. An important distinction in this model is that information takes two forms, feedback and “anticipatory” feed-forward. Depending upon the states of the information as compared with the goals, different actions are called for. This tends to reduce uncertainty and increase more timely states of system equilibrium brought about in the control processes (e.g. immediate actions or longer-term policy making and/or planning). With adequate resources, feedback information is relatively easy to obtain and interpret. Feed-forward information is not easy without new futures forecasting methodologies.

Forecasting seeks to anticipate the future in an effort to reduce the domain of the unknown. It involves the process of examining alternative courses of action and the probable outcome of pursuing various alternatives in terms of costs and risks so that a desirable choice can be made from among them. In reality, policy and planning decisions are seldom made with certainty. There is seldom any reliable data about the future, and it probably cannot be adequately forecast through extrapolation of current trends. Systematic forecasting and futures research are therefore embedded in the “inexact sciences”, those that rely on subjective human judgment. The opinion of experts, those who have extensive explicit and implicit knowledge about a particular domain, is used as a source of data about the future.

Forecasting methods strive for effective application to real-world problems. We cannot, and need not, have extensive knowledge of the future. By limiting the forecast time range or scope, or by simplifying a complex environment by modeling the system or representing it in more abstract terms, useful information for decision-making is generated. Any reduction in uncertainty is significant, as it may reveal critical leverage points within a system; it may also reveal situations that are resistant to intervention. It is believed that futures forecasting can and does systematically reduce uncertainty of event occurrence probabilities and trend levels in short, medium and long range time frames.

Accordingly, it would be desirable to employ a futures forecasting engine that harnesses networked informed opinion. Existing methods using expert probability and trend level assessments need to be significantly modified and that new methodologies and methods need to be invented, refined, tested and advanced. New theories addressing the dynamic nature of complex socio-technical systems—e.g. complex adaptive systems, chaos theory, catastrophe theory, swarm intelligence and fuzzy logic—need to be incorporated into ways of thinking about (and investigating) alternative futures or slowly emerging, long-term, problems. Traditional analytical methods are not suitable for addressing ill-defined and emerging problems or opportunities that have little or no data about them. Many existing forecasting tools (e.g. extrapolation, model building, etc.) are based on past rules and existing trends and are ill-suited to times of unique and/or rapid change or for time frames beyond five years. What seems to be more appropriate is to identify critical developments and project their probabilities, projected rates of change, imbalances, gaps and other critical factors. Subsequent analysis may reveal a basis for determining where and when critical leverage points within the complex system can be exploited to reduce uncertainty and encourage actions.

### SUMMARY OF INVENTION

In accordance with the present invention, a futures forecasting method employs a Futures Forecasting Engine (FFE) which creates data gathered from participants that can assist in describing the nature, components and dimensions of emerging/potential problems or opportunities and assists in prioritizing approaches to addressing or capitalizing on them. The Futures Forecasting Engine is a dual-mode web-based methodology that creates content and seeks to systematically remove uncertainty about alternative futures. It is an open architecture methodology that can accommodate the widest of topics and timeframes.

The forecasting engine has two modes from which users can choose: 1) Conventional Mode, and 2) Needs/Supplies/Rights (NSR) Mode. Both follow similar procedures. The NSR Mode differs in the manner that it manages the forecasting of trends. The overall process has four (4) main stages. As the forecasting engine's architecture is open, the coordinator or the computer can elect to incorporate all or select the appropriate steps for each forecast. The selections are made during the study setup, but can be adapted later if necessary.

1. The Swarm stage establishes the panelists and their e-mail addresses.

2. The Zero Round Alpha/Beta stage is initiated. The Zero Round Alpha sub-phase solicits trend and event developments from panelists, and the Zero Round Beta sub-phase establishes which trends and events will be utilized in the study and refines and prioritizes them.

3. The two-round Delphi stage is initiated. The First Round gathers participants' estimates of event probabilities and trend levels over time, and the forecasting engine calculates all statistics, and prepares feedback (including calculation of the median and semi-inter-quartile ranges of responses). The Second Round gathers participants' revised estimates of event probabilities and trend levels (utilizing feedback and their first round personal estimates).

4. The Output stage is entered when a study is completed after a pre-established time has elapsed, or panelist number thresholds have been exceeded, and all statistics are calculated. Finally, automated report generation is performed via a flexible backend.

The above process is the same for both the Conventional and Needs/Supplies/Rights Modes of the forecasting engine, except for the treatment of trends. The Conventional Mode handles trends as projected “real” levels (e.g. Gross National Product, sales, votes, educational indicators, pollution, Quality of Life, etc.), while the Needs/Supplies/Rights Mode projects levels of “needs for something,” “supplies of something,” and the “right to something” on a ten-point scale.

The forecasting engine could analyze each trend level or change individually over time, a feature called the Dynamics Index (DI). It could also look at differences between Needs and Supplies levels or further analyze Needs and Supplies levels by multiplying the differences by the level of each Right to have the specific Need and Supply level. This produces a rank ordering of “urgencies” for actions, referred to as an Action Urgency Index (AUI). This unique capability is extremely useful for public policy makers and planners as well as business leaders. The forecasting engine harnesses the power of networking, computer processing and human knowledge to create content in times of high and increasing uncertainties. It seeks to add value to content and insights concerning the future. The return on investment (ROI) of reducing even small uncertainties about the future is significant.

The Futures Forecasting Engine methodology offers substantial multi-method research and development in networked forecasting. It is a systematic and automated process that involves multiple techniques and stages, with multiple outputs. The process handles both quantitative and qualitative data and is capable of processing or adding value to that data. The methodology does not purport exactness; rather it systematically tries to reduce uncertainty while creating data about the future.

The forecasting engine employs a multi-method approach to improve the reliability and quality of the forecasting results. After the preliminary study setup and management of the Futures Forecasting Engine, the process unfolds over four main stages: 1) the Participant Swarm Stage identifies and contacts panelists for the study; 2) the Zero Round Alpha sub-phase solicits trend and event developments from panelists, and the Zero Round Beta sub-phase refines and establishes which trends and events will be utilized in the study and prioritizes them; 3) the two-round Online Delphi Stage assesses the event and trend developments; and 4) the Report Generation and Interpretation Stage offers sophisticated analysis and summary of data collected.

Other objects, features, and advantages of the present invention will be explained in the following detailed description with reference to the appended drawings.

### BRIEF DESCRIPTION OF DRAWINGS

FIG. 1 illustrates the traditional cybernetic model for futures decision making.

FIG. 2 illustrates an adapted, feed-forward model for futures decision making in contrast to FIG. 1.

FIG. 3 illustrates a system overview of the futures forecasting method of the present invention.

FIG. 4 shows an example of a Main Screen for logging onto the forecasting engine via a password-protected web interface.

FIG. 5 shows a Study Administration Panel to which the user is directed after login.

FIG. 6 shows an example of an Add New Study Form to create a new study.

FIG. 7 shows an example of an Update Study Form for modifying or deleting existing studies.

FIG. 8 shows an example of a Study Management Rules Form for specifying rules when a new study is created.

FIG. 9 shows an example of an Email Participants Form for tracking the progress of individual participants in a study.

FIG. 10 provides an overview of the Swarm Stage which automates the selection of panelists and creates an expert database for a study.

FIG. 11 shows an example of a Nomination of Seed Experts Form by which initial participants are selected.

FIG. 12 shows an example of an Update Seed Swarm Form for setting up the details of a formal, electronic letter (email) to be sent to each initial panelist to participate in a study.

FIG. 13 shows an example of a Seed Nomination Form Letter that is generated from the Update Seed Swarm Form.

FIG. 14 shows an example of an Update Nomination Form for specifying the content of an automated invitation letter sent via e-mail to those panelists who choose to participate.

FIG. 15 illustrates the Zero Round Alpha and Beta sub-phases of Stage Two of the futures forecasting engine.

FIG. 16 shows a setup matrix for the administrator to select portions of the survey areas for inclusion in a study.

FIG. 17 shows an example of a Developments Input Form by which panelists in a study are asked to input their thoughts regarding the key developments in each cell of the matrix.

FIG. 18 shows an example of a Zero Round Beta Transform Developments Form by which the administrator reviews all suggested developments (trends and events) generated during the Alpha sub-phase to determine which will be utilized in the study.

FIGS. 19 and 20 show examples of how developments (trends and events) are accepted for the Events Database or the Trends Database.

FIG. 21 shows the Update Event Introduction Form and FIG. 22 shows the Update Trend Introduction. Form for trends and events that will be presented to participants during the Delphi stage.

FIG. 23 illustrates a two-round automated Delphi questionnaire process for Stage 3 of the futures forecasting engine methodology.

FIG. 24 shows an example of a Trend Question Form for use in Round One of the Delphi Stage.

FIG. 25 shows an example of a Trend Question Form for use in Round Two of the Delphi Stage.

FIG. 26 shows an example of an Event Question Form for use in Round One of the Delphi Stage.

FIG. 27 shows an example of an Event Question Form for use in Round Two of the Delphi Stage.

FIG. 28 illustrates Output Stage 3 for report generation and interpretation in the futures forecasting engine methodology.

FIG. 29 illustrates a sample Events Analysis Report.

FIG. 30 illustrates a sample Trends Analysis Report

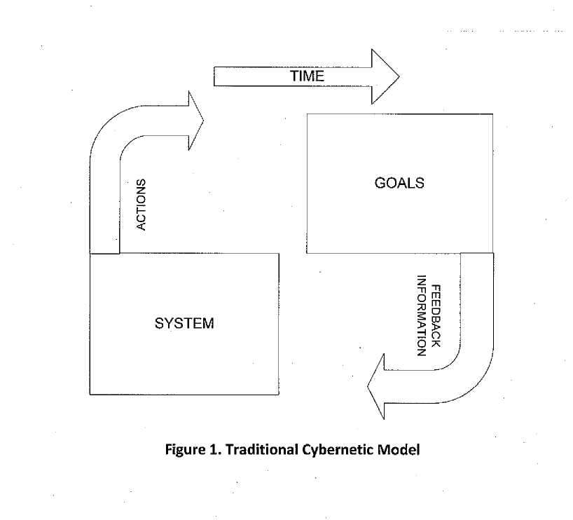

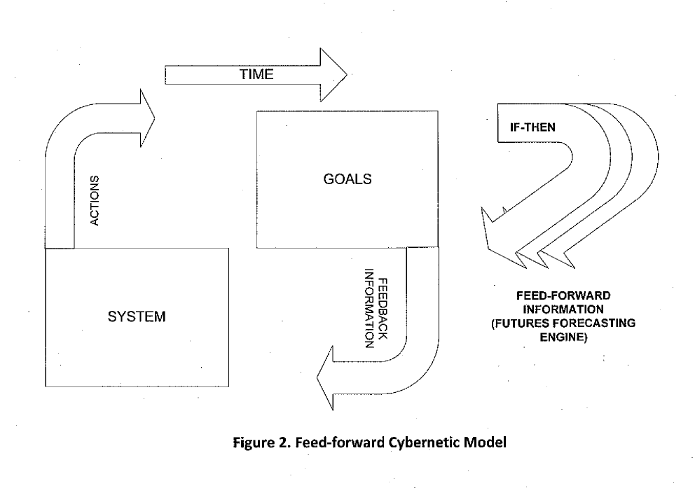

### DETAILED DESCRIPTION OF INVENTION

In the following detailed description, certain preferred embodiments are described as illustrations of the invention in a specific application, network, or computer environment in order to provide a thorough understanding of the present invention. Those methods, procedures, components, or functions which are commonly known to persons of ordinary skill in the field of the invention are not described in detail as not to unnecessarily obscure a concise description of the present invention. Certain specific embodiments or examples are given for purposes of illustration only, and it will be recognized by one skilled in the art that the present invention may be practiced in other analogous applications or environments and/or with other analogous or equivalent variations of the illustrative embodiments.

Some portions of the detailed description which follows are presented in terms of procedures, steps, logic blocks, processing, and other symbolic representations of operations on data bits within a computer memory. These descriptions and representations are the means used by those skilled in the data processing arts to most effectively convey the substance of their work to others skilled in the art. A procedure, computer executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “processing” or “computing” or “translating” or “calculating” or “determining” or “displaying” or “recognizing” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The term “Internet” is intended to include any wide area digital network or network of networks connecting a universe of users via a common or industry-standard (TCP/IP) protocol. Users having a connection to the Internet commonly connect browsers on their computing terminal or device to websites that provide informational content via web servers. The Internet can also be connected to other networks using different data handling protocols through a gateway or system interface, such as wireless gateways using the industry-standard Wireless Application Protocol (WAP) to connect Internet websites to wireless data networks. Wireless data networks are now deployed worldwide and allow users anywhere to connect to the Internet via wireless data devices.

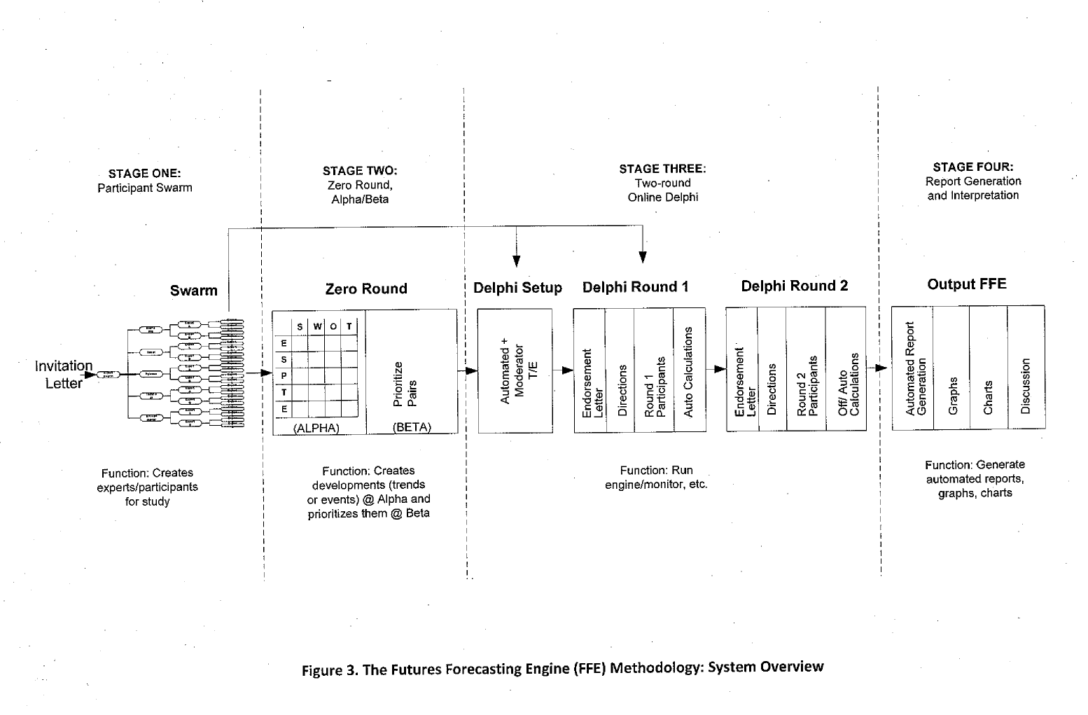

A system overview of the unique approach of the futures forecasting method of the present invention is illustrated in FIG. 3 and discussed in more detail below. The overall process has four (4) main stages: (1) the Swarm stage; (2) the Zero Round Alpha/Beta stage; (3) the two-round Delphi stage; and (4) the Output stage.

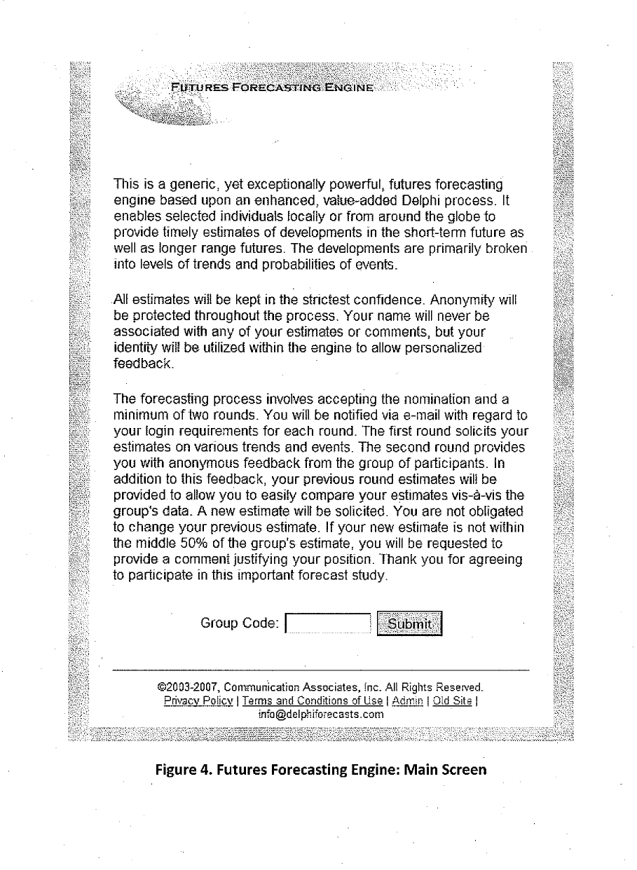

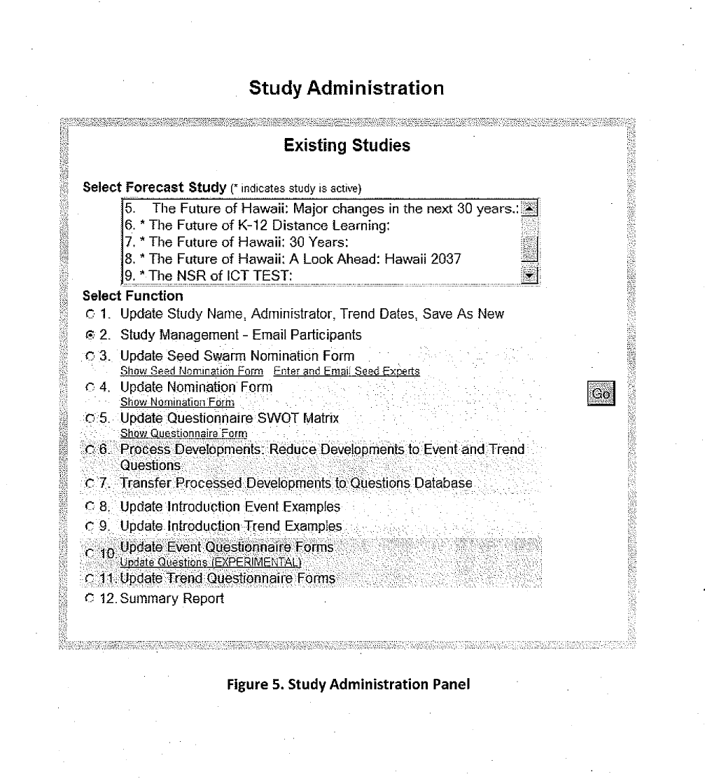

The futures forecasting method is designed to take advantage of the Internet and its World Wide Web capabilities. Custom software has been developed for this purpose and is referred to as the Future Forecasting Engine (see Appendix I for summary of the FFE program). The FFE software system is accessible via any World Wide Web browser connected to the Internet. To access the forecasting engine, an administrator logs into the forecasting engine via a password-protected web interface (see sample Main Screen in FIG. 4). After login, the user is directed to the Study Administration Panel (see FIG. 5). This page enables selection of a particular forecast study and access to all of the main system functions. This panel is accessible from anywhere in the administration interface via a menu item.

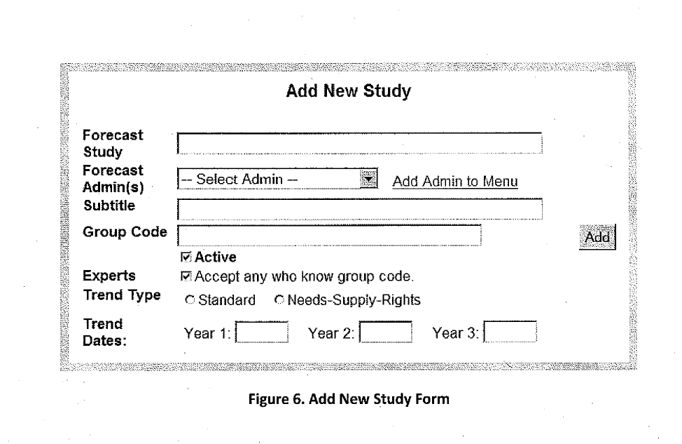

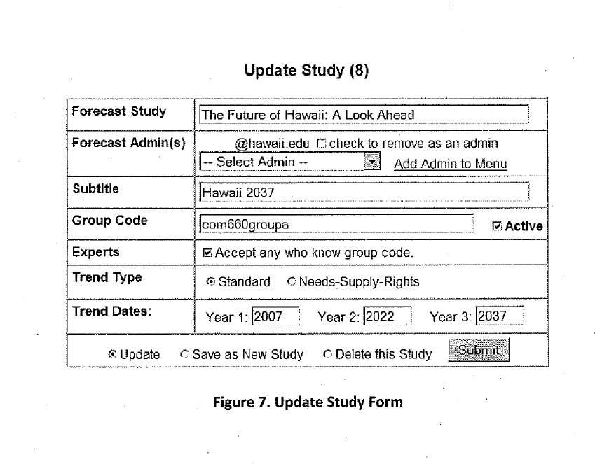

To create a new study, the administrator enters the Add New Study Form (see FIG. 6) and enters some basic information about the study, including: study name and subtitle, administrator, whether it is active, and whether to limit the study to participants with a specific code. He or she also specifies one of two “trend types” (Conventional or NSR) and establishes a time-frame for the study (“trend dates”). Existing studies may be modified or deleted via the Update Study Form (see FIG. 7).

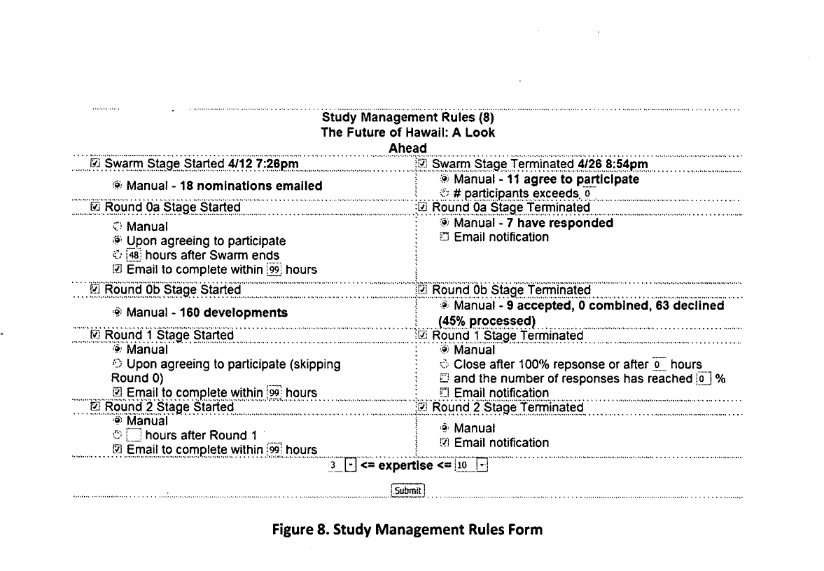

Once a new study is created, the administrator specifies a number of rules using the Study Management Rules Form (see FIG. 8). This manages the flow of steps throughout each study. A unique feature, and one of the major strengths of the forecasting engine, is its ability to self-manage after initial setup. The administrator has many choices enabling automation, or he or she may choose to perform certain tasks manually.

Referring again to FIG. 3, during the Swarm stage, the administrator selects the number of desired participants to whom an invitation letter (email) is sent inviting participation in the study. The forecasting engine will terminate the stage and switch to the Zero Round Alpha once this threshold is exceeded by responses of invited participants.

There are several choices for initiation of the Zero Round Alpha phase: it may be set to start at the time participants agree to take part in the study, or the administrator may specify a number of hours after the Swarm is complete as the starting time. There is also an option to email participants a reminder to complete the phase within a designated number of hours. The function of the Alpha phase is to create data representing developments (trends or events), while the function of the Beta phase is to categorize them. The administrator can monitor the percentage of responses via the Study Management Rules Form, in order to decide when to conclude the phase. He or she may elect to send participants an email at the start and/or termination of the Zero Round Alpha.

The conclusion of the Zero Round Alpha and the management of the Zero Round Beta sub-phases require manual switching. This is to ensure that the developments submitted by participants are high quality, clearly articulated, and distinct.

The administrator may select that Round One of the Delphi be automatically initiated at the time participants agree to take part in the study (skipping the Zero Round). There is also an option that instructs the forecasting engine to automatically send an email to participants asking them to complete the stage within a selected number of hours. The function of the online Delphi stage is to run the futures forecasting engine with responses from the invited online participants in two successive rounds. The termination of this stage has several automated options: the administrator may choose to end the phase after 100% of the respondents participate or after a predetermined number of hours. If the number of hours is specified, one may also choose a predetermined percentage of responses. The administrator may set up the automated email function that generates a message at the termination of the Round One Delphi phase. The forecasting engine then automatically switches to Round Two of the Delphi.

The administrator may set a predetermined number of hours after which to automatically initiate Round Two of the Delphi. He or she may also choose to email participants with instructions to complete the phase within a given number of hours. He or she may elect to send participants an email at the termination of the Round Two Delphi phase.

Another automated feature accessible via the Study Rules Management Form is the acceptable Expertise range (1 being the lowest, 10 being the highest). During the online Delphi, participants are asked to self-assess their level of expertise for each development. This feature allows the administrator to set “alternative threshold levels” for the acceptable expertise levels in the study. When the engine performs automatic data analysis and report generation (discussed below), all data that are not associated with a minimum level of expertise will not be included in the final calculations for that development. Once these rules have been established, they can be overridden; but these features automate the process to a great degree.

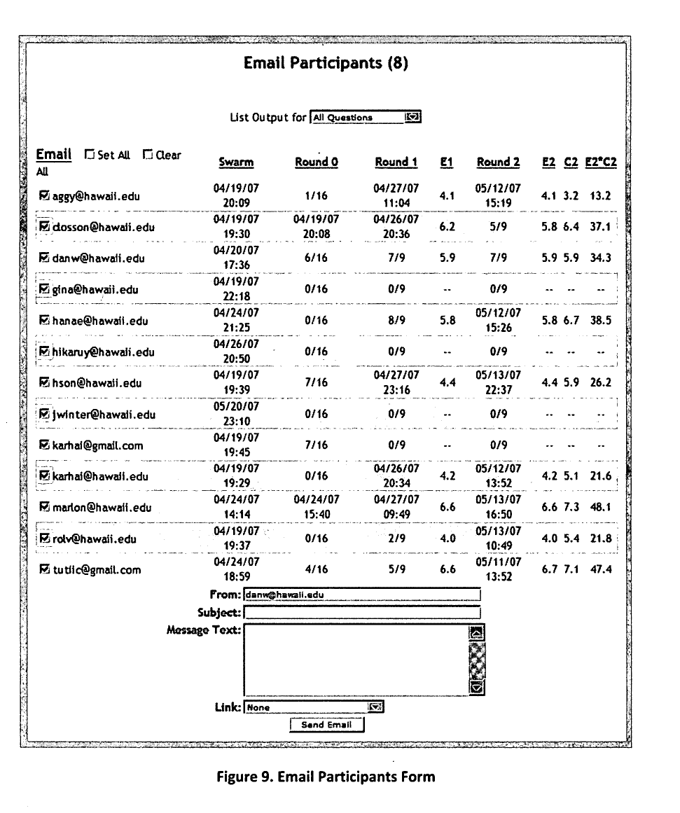

At any point during the study, the progress of individual participants can be tracked via the Email Participants Form (FIG. 9). This provides the following information: email, date of agreement to participate, the number of developments submitted during the Zero Round Alpha, progress in each round of the Delphi, and average Expertise for each round of the Delphi (E1, E2). In addition, the average Certainty that Round Two Delphi developments will occur (C2), and the product of Expertise and Certainty (E2*C2) are displayed. Each column can be sorted. The administrator can also use this form to send messages to the group or to individual participants (e.g. a reminder that one has not completed a particular task).

Stage One: The Participant Swarm

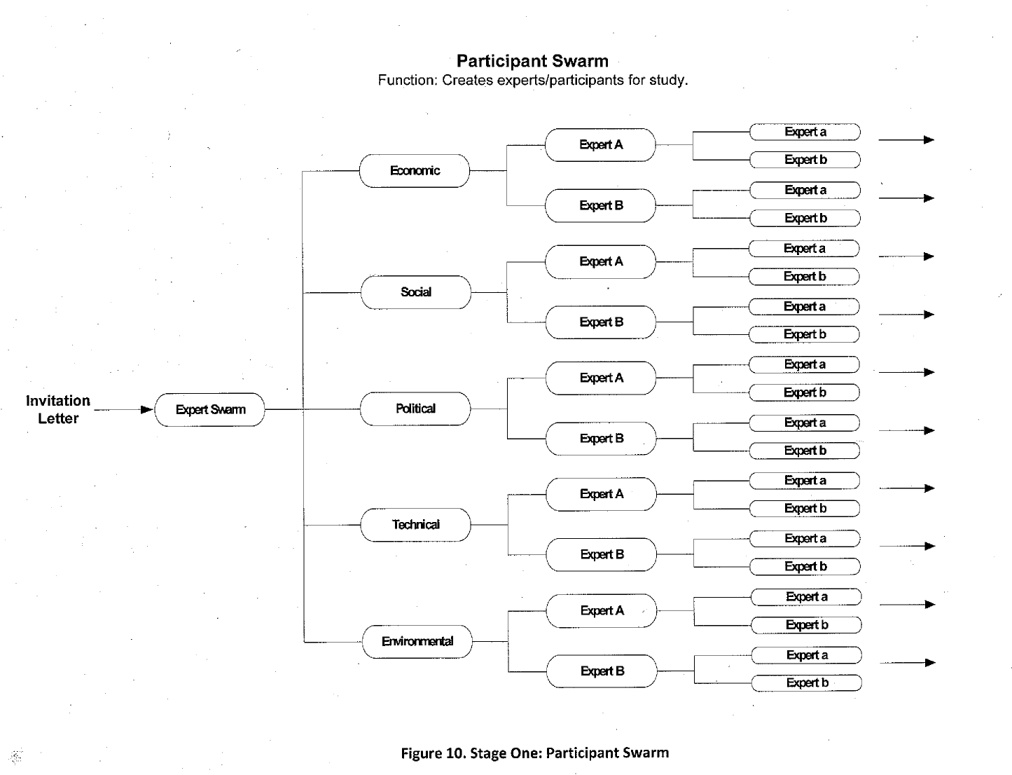

The Swarm Stage automates the selection of panelists and creates an expert database. FIG. 10 provides an overview of this stage. This is an extremely important step in the overall forecasting process as it establishes and removes biased selection of panelists while at the same time distributing the panelists' foci of interest/expertise. One to two panelists in each of the Social, Economic, Political, Technical and Environmental domains are selected to participate in the study. These initial participants are selected via the Nomination of Seed Experts Form (see FIG. 11).

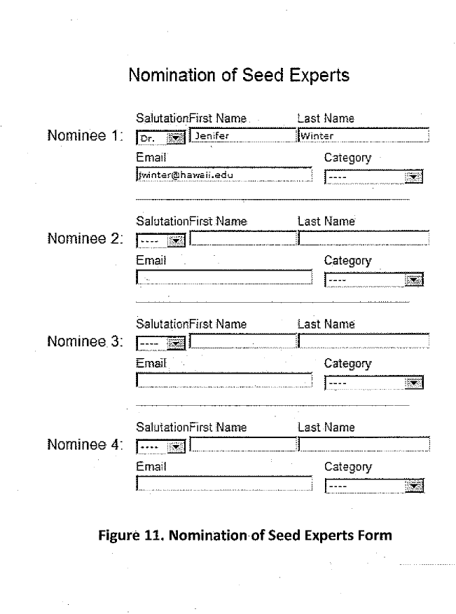

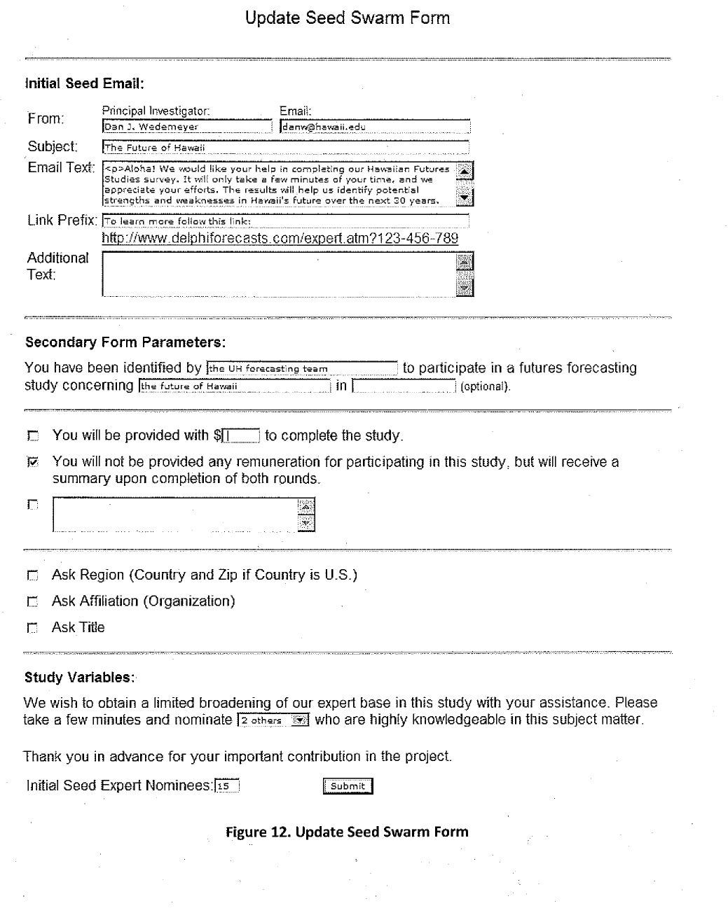

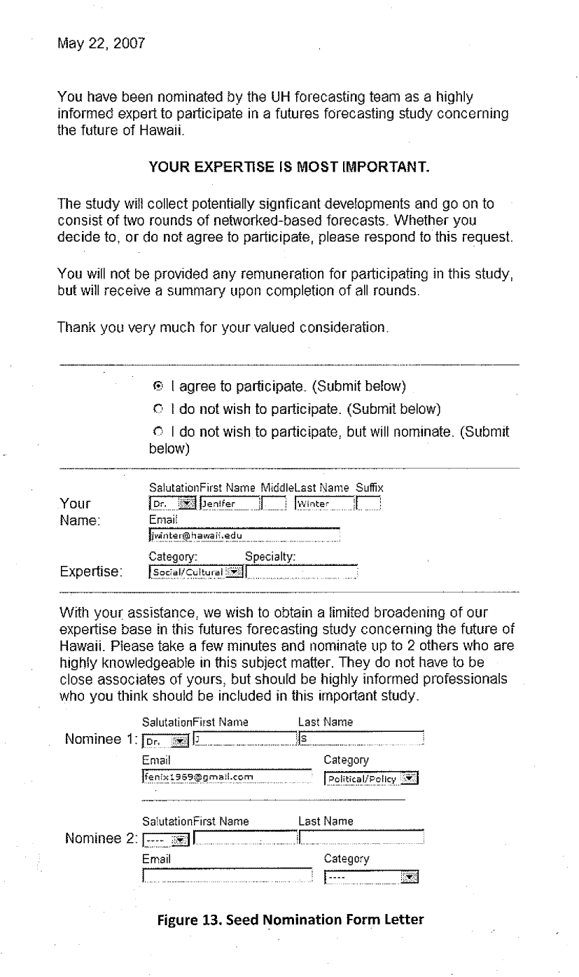

The Swarm Stage begins by sending each initial panelist a formal, electronic letter of request to participate. The details of this letter can be set up using the Update Seed Swarm Form (see FIG. 12). An example of the Seed Nomination Form Letter that is generated from this form is provided in FIG. 13. The people nominated by the first wave of the participant Swarm are subsequently asked to nominate additional potential panelists (typically two, although this number can be modified). Each of the potential panelists is given the same opportunity as described above to participate, not participate and nominate others, or not to participate or nominate others. This branching activity continues until the desired number of panelists in each domain is obtained (along with corresponding e-mail addresses, which are captured in an expert database).

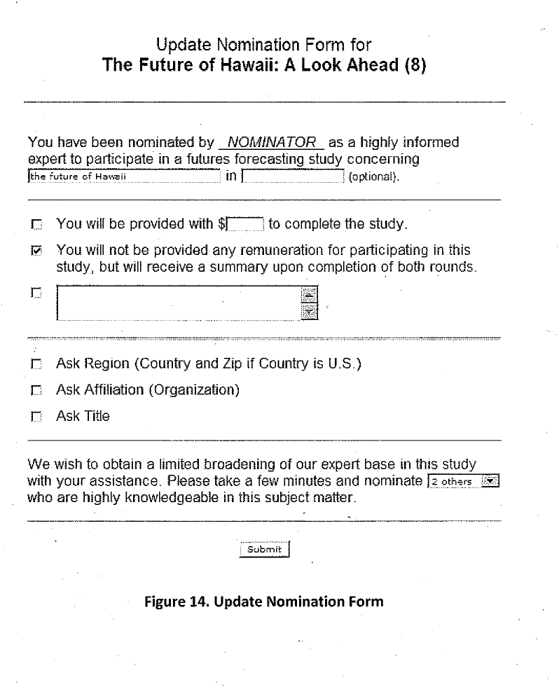

Those who choose to participate are sent an automated invitation letter via e-mail. The Update Nomination Form (FIG. 14) specifies the content of this letter. This letter establishes the focus of the study, the timeframe in “future years,” how/who will use the data created in the study, and if remuneration will be provided. It also provides a contact person, signature, title, and affiliation of the sender(s). Once the desired number of panelists is achieved, the forecasting engine automatically initiates the Zero Round Alpha and Beta Stage based on the rules specified during setup.

Stage Two: Zero Round Alpha Sub-Phase

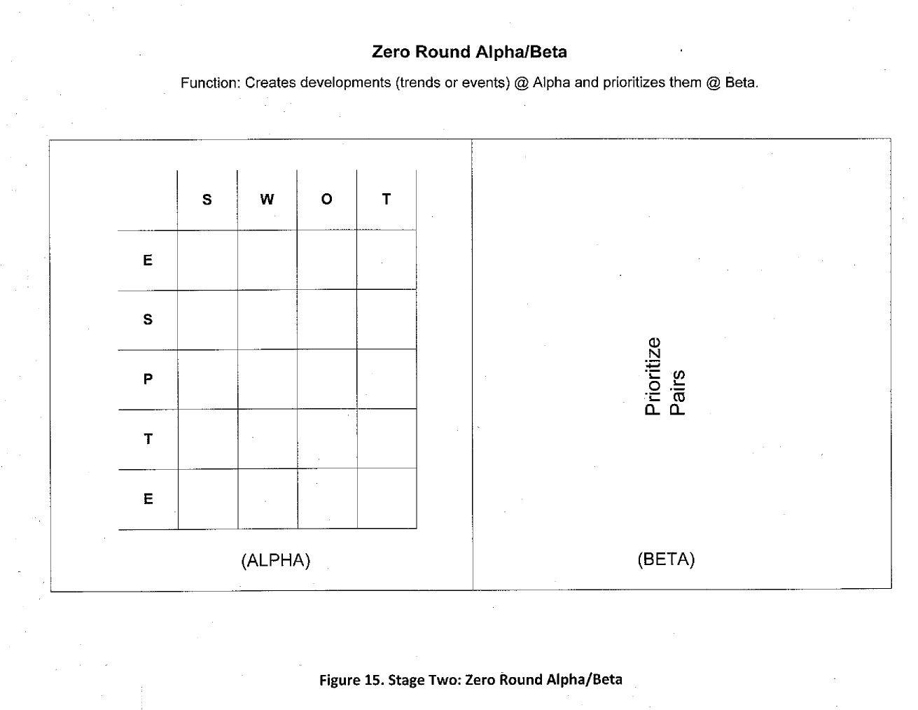

Stage Two is divided into two sub-phases: the Zero Round Alpha and Beta (outlined in FIG. 15). The Alpha sub-phase focuses on trend and event generation. It is intended to facilitate key development suggestions from each of the panelists. Participants are sent an access URL (web address). When the panelist accesses the secure URL, he or she is asked to initiate input by entering his or her e-mail address and the forecast study name. All responses are encrypted, and the panelists are assured that all inputs will be kept in the strictest of confidence. In addition, while comments are captured, they are not attributed to any participant in any phase of the methodology. The e-mail address is used solely for administrative purposes. Each panelist is asked to provide a qualitative response to questions in up to twenty (20) categories. These categories are derived by a four by five (4×5) matrix of Economic, Social, Political, Technical and Environmental (ESPTE) developments as they correspond to Strengths, Weaknesses, Opportunities and Threats (SWOT) related to the research focus (see Table 1 below). SWOT analysis is a technique that seeks to identify both internal factors (strengths and weaknesses) and external factors imposed by the environment (opportunities and threats) faced by an organization (or other entity, e.g. region) in order to guide strategic planning.

TABLE 1
SWOT/ESPTE Developments Matrix

| Strengths (of) | Weaknesses (of) | Opportunities (for) | Threats (to) |
|---|---|---|---|
| Economic | Economic | Economic | Economic |
| Social | Social | Social | Social |
| Political | Political | Political | Political |
| Technical | Technical | Technical | Technical |
| Environmental | Environmental | Environmental | Environmental |

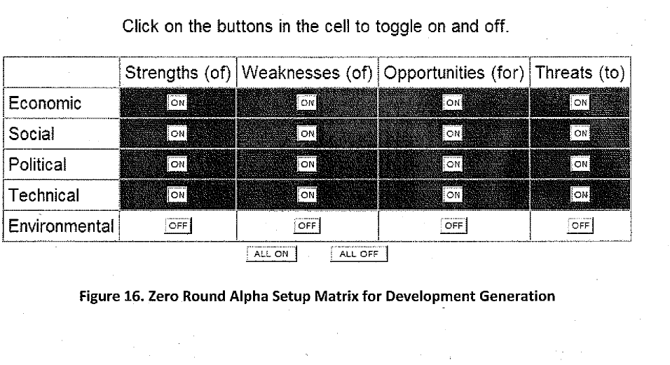

During setup, the administrator is able to select all or portions of the matrix cells for inclusion in a study (e.g. just Economic and Technical developments or just Weaknesses and Threats). Each of the cells can be turned on or off, as illustrated in FIG. 16.

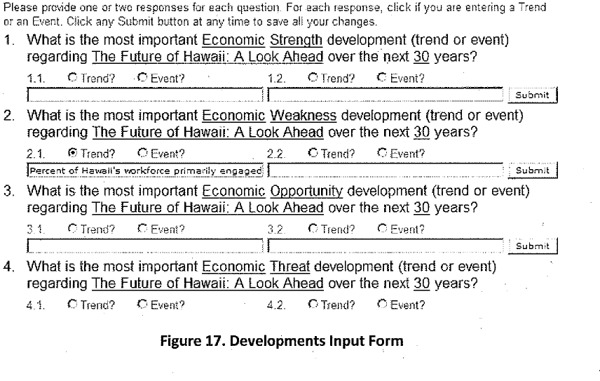

Panelists are asked to provide their thoughts regarding the key developments in each cell of the matrix. An example of this Developments Input Form is shown in FIG. 17. Panelists see one question at a time and have the opportunity to contribute two or more comments for each. After each question is completed, the panelist is prompted to electronically submit his or her input. The forecasting engine stores this information in a database that keeps track of each participant's progress in the study. When all developments are completed, the forecasting engine will then sort and compile all data and store it in cells for further calculations. The forecasting engine will then prepare the Zero Round Beta questionnaire.

Stage Two: Zero Round Beta Sub-Phase

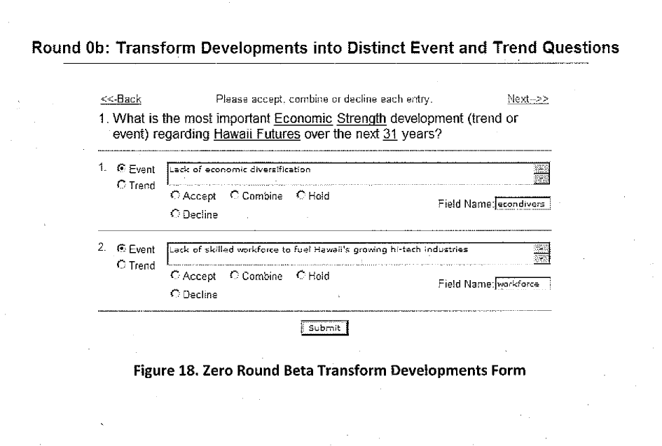

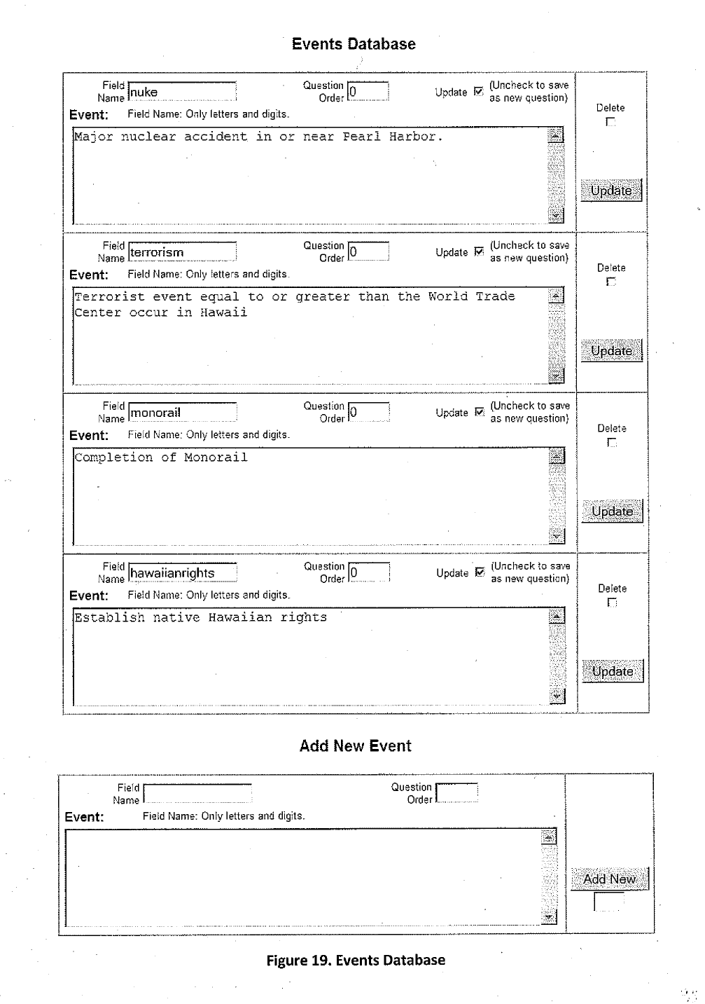

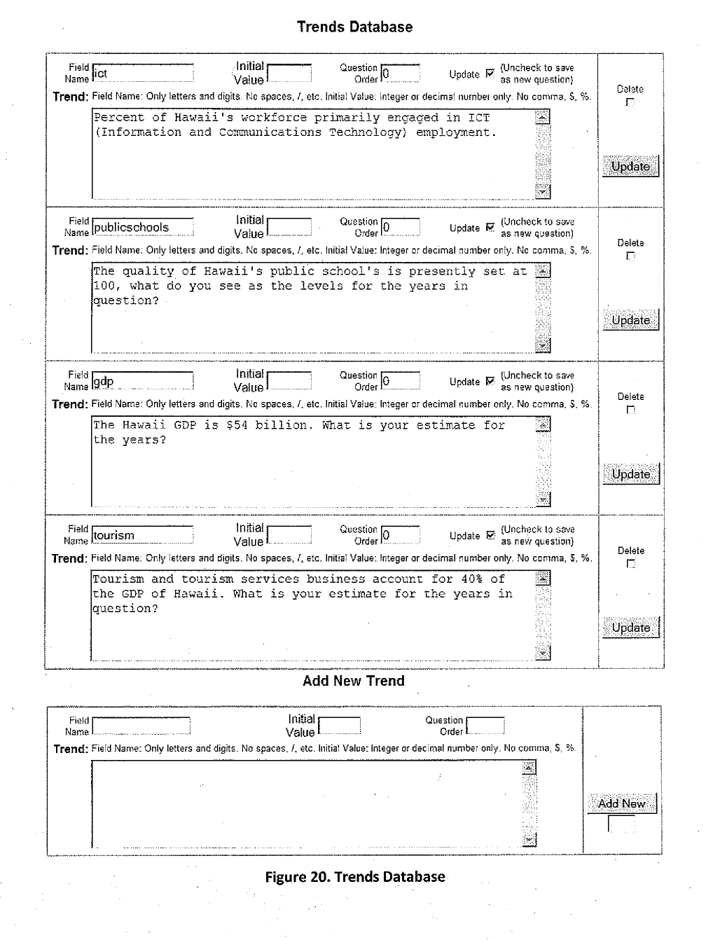

The Zero Round Beta sub-phase establishes which trends and events generated during the Alpha sub-phase will be utilized in the study, and it refines and prioritizes them. At this point, the administrator reviews all suggested developments (trends and events) via the Zero Round Beta Transform Developments Form (see FIG. 18) and chooses one of the following options for each trend or event: accept, decline, or hold the development. Items that the administrator decides to “hold” are stored in a separate location until the administrator can review them and submit them for entry into the Round One questionnaire after any necessary editing (or disregard entirely). Developments that are accepted are sent directly to the Events Database or the Trends Database (see FIGS. 19 and 20) for inclusion in Delphi Stage 3. The administrator can access this list to edit or add new events or trends as needed. These decisions set the conditions for the subsequent generation of trend and event questions for Round One of the online Delphi stage.

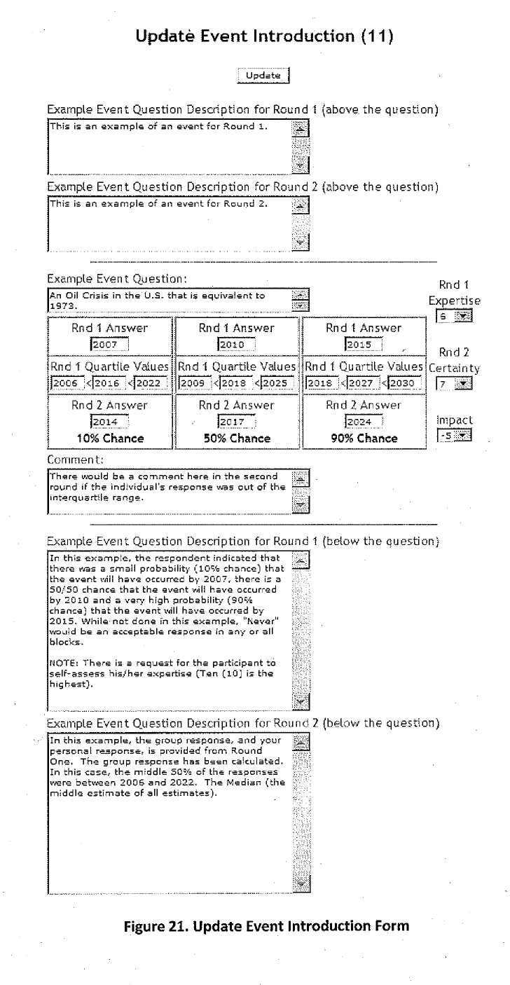

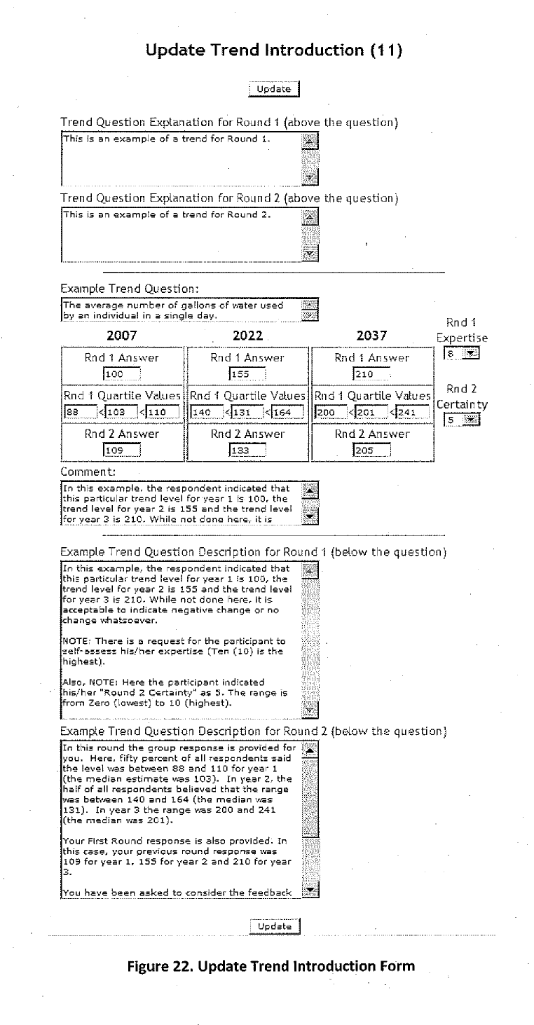

It is important to note that, at any point during the Zero Round Alpha/Beta (or subsequent online Delphi), the administrator can alter the text of any of the questionnaire items (i.e. in case of a typographical error or unclear phrasing). At that time, he or she also has the option of emailing the originator of the question to inform them of this change. The final step of this stage is to review and, if necessary, modify the examples for trends and events that will be presented to participants during the Delphi. FIG. 21 shows the Update Event Introduction Form and FIG. 22 shows the Update Trend Introduction Form.

Stage Three: Two-Round Online Delphi

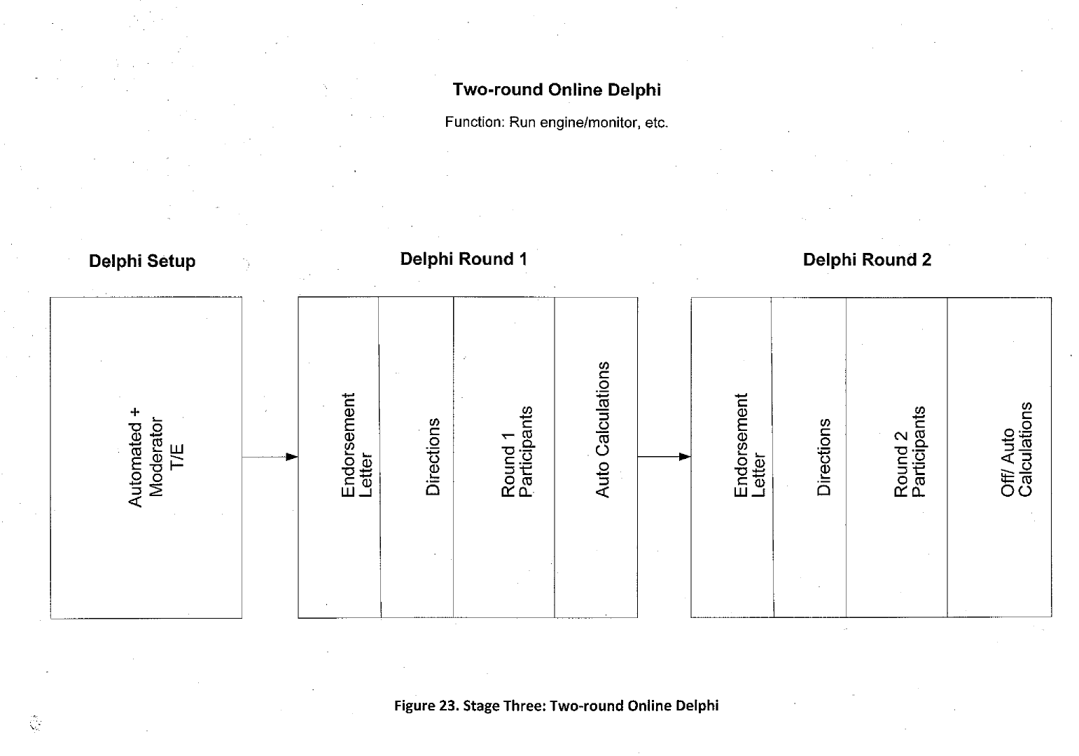

The next stage of the forecasting engine methodology employs a two-round automated Delphi questionnaire process (see FIG. 23). The online Delphi Stage employs the event and trend questions generated in the Zero Round Alpha/Beta Stage. All event and trend questions go through two rounds of estimates. Depending upon the administrator's choice during initial setup, this handling of trends in this Delphi may take one of two forms: Conventional Mode or Needs/Supplies/Rights (NSR Mode) which are discussed at length below.

Round One of the Delphi Stage outlines a number of trend and event questions and asks each respondent to estimate his or her personal level of expertise for each (1-10, 10 being the highest). As noted earlier, during setup the forecasting engine can be programmed to disregard all estimates by those respondents who assess themselves as being below any specified threshold of expertise (e.g. 3 or below, 4 or below, etc.) It is assumed that not all panelists will be experts in all areas under question. This promotes the inclusion of only the estimates of self-assessed high expertise. The forecasting engine automatically concludes Round One when an acceptable number of expert responses have been received. This number can be established at setup time and administered by the Engine, or the administrator may choose to manually close the round. The desired number of panelists varies by application; any number is acceptable. A rule of thumb for the minimum is that the first round responses should fall into a range from 30-60 respondents, and the second round within a range from 15-30 advanced experts.

Once Round One is complete, the forecasting engine automatically calculates the necessary statistics (described below) and switches the engine to the Round Two phase. The forecasting engine automatically notifies each panelist via e-mail when it is time to enter the second round estimates. Alternately, the administrator can do this manually. The forecasting engine automatically calculates the range of each trend level/year and each event probability/year gathered in the previous round. These calculations provide the median and the semi-interquartile range (the middle 50% of all panelists' estimates). This information is provided as feedback to each participant. In addition, each panelist receives his or her First Round estimates as a reference/reminder. The panelist is then asked to provide a Round Two estimate. If the Round Two response is outside the semi-interquartile range, the forecasting engine prompts the respondent to provide an option to comment or justify the estimate. In this way, the engine is capable of collecting qualitative as well as quantitative information. The forecasting engine stores the comments in question-sorted cells for later use in analysis and in the final report. The comments are then ranked by calculating various formulas based on impact, expertise and certainty (described below).

Once the Engine reaches its pre-established number of responses it closes Round Two and automatically performs a number of calculations. These calculations can be manipulated by the user or forecasting engine program for the final report. The various alternatives in sorting and manipulating the forecasting data include various Event List sorts, Trend List sorts, Individual Confidence/Expertise level sorts and Composite Confidence/Expertise level calculations/manipulations.

To summarize, in Round One the forecasting engine guides panelists to establish trend levels and event probability estimates. In addition, participants are asked to self-assess their level of Expertise (E). Expertise levels can be established prior to the study and can be used to self-calibrate the “line of best estimate fit” after the study. Low Expertise and Certainty levels for each panelist's inputs are examined automatically and discarded from the forecast pool for each trend and event if they fall below the acceptable expertise levels. They are also asked to self-assess their level of Certainty (C) about estimates for each trend and each event question. Finally, they are asked to assess the Impact (I) of each event if it were to occur.

After Round One data from all panelists are collected, the engine automatically calculates the following: 1) average Certainty (C) of each forecast; 2) average Expertise (E) for each forecast; 3) average Impact (I) of each event if it is to occur; 4) Expertise level of the panelists multiplied by the Certainty level (i.e. E*C) for each event and each trend; and 5) Impact of each event if it is to occur multiplied by the Expertise level and the Certainty level (i.e. I*E*C).

The engine then automatically switches to Round Two of the Delphi. In Round Two, the forecasting engine provides feedback to each panelist, consisting of the calculated semi-interquartile range (middle 50% of all estimates for each trend and each event question), the median for each trend and event development, and each panelist's personal Round One estimates. Each panelist has an opportunity to revise trend levels and event probability estimates based on this feedback. In addition, each panelist has an opportunity to add comments (qualitative data) for each trend and event question. Finally, the forecasting engine solicits an assessment of the Impact (−10 to +10) of each event if it were to occur.

After Round Two data from all panelists is collected, the forecasting engine automatically performs a sophisticated calculation and analysis of final event and trend forecasts. These include: 1) rates of change in probabilities of event occurrences (±p); 2) average percentage change per year; 3) a summary of years when there is a slight (10%), moderate (50%), and strong (90%) probability (p) that each event will occur; and 4) calculation of specific levels of each trend development and the percentage change per year (slope, or m).

These data are presented in a display table and the administrator can easily view or sort (from high to low) each trend or event by highest certainty (C), highest Expertise times Certainty (E*C), highest Impact times Expertise times Certainty (I*E*C), etc. These novel calculations and their practical utility will be further elaborated in the discussion of Stage Four.

Handling of Trend Developments in the Online Delphi

The advancement of the Futures Forecasting Engine assumes that alternative futures are broken into two types of developments: trends and events. Trends are gradual indicators over time (e.g. quality of life). Events behave quite differently; they occur abruptly (e.g. the passage of a law or a medical breakthrough). In futures research it is often assumed that events drive trends and/or other events; to a lesser degree trends may influence, but not necessarily drive, other trends.

The forecasting engine assumes that trends may or may not change over time. They may increase, decrease or remain constant. Trends have differing units of analysis. Some may be indexed to a particular level in the present (e.g. the public school system may be ranked at 50^{th} in the nation). As noted previously, the forecasting engine allows selection between two different modes: Conventional and Needs/Supplies/Rights. These modes differ substantially in how they handle trends.

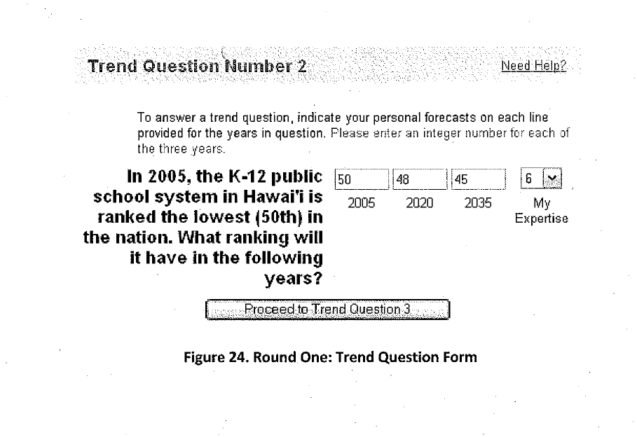

In Conventional Mode, panelists are asked to estimate the level in specified years in the future during Round One (see FIG. 24). In this instance, the respondent chose to elevate the rank of the Hawaii public school system in 15 years from 50^{th} place to 48th. Fifteen years later they estimate it will increase from a level of 48 to a level of 45. On the other hand, a panelist might estimate no change whatsoever over the entire 30 year period. In the above example the respondent rated his/her expertise level at six (6) on a scale of 0-10.

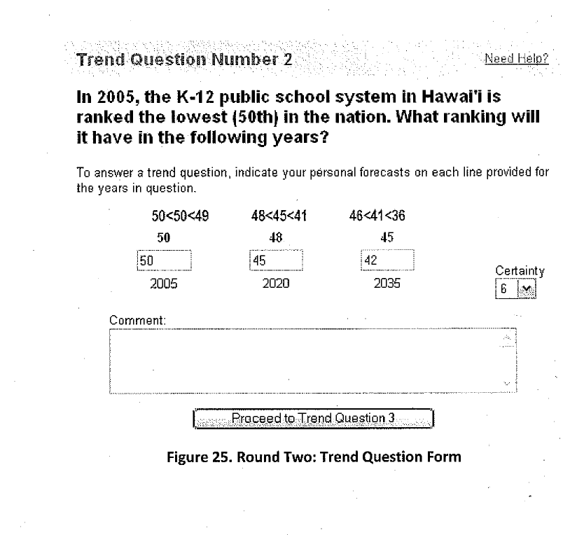

During Round Two in Conventional Mode, the panelists see a summary of the previous round, in addition to their own previous estimates (see FIG. 25). After reviewing the inputs of the other panelists provided by the forecasting engine, the respondents may choose to change the values for the years 2020 and 2035 or to keep the same values they estimated in the first round. If their response falls outside of the semi-interquartile range they are asked to justify their response.

The choice whether to use the second mode, Needs/Supplies/Rights (NSR), is dictated by the problems at hand. As stated, while the events data generation capabilities and manipulation (as well as the entire forecasting engine process) can remain the same as set out in the Conventional Mode, the trend data is quite different. In the Needs/Supplies/Rights Mode, each trend is broken out into three dimensions: Needs (for), Supplies (of), and Rights (to) a particular development. In other words, the need for a particular development, the available supply of something, and the right (i.e. the cultural and/or human) to have something are the foci of the forecasts.

Each of these dimensions is further separated into three time frames (any span of years can be assigned by the administrator at setup). The respondent is asked to set the trend level for Needs/Supplies/Rights for each of the three years using a pull-down menu (from 10 to 1, ten being highest). In the Needs/Supplies/Rights Mode the estimated units are not a real “unit” quantity of the trend; rather, each panelist is asked to set “benchmark” levels (10 to 1) and to estimate how these may vary over the years and how they may differ between Needs and Supplies. If the respondent sees the Needs and Supplies in balance, the responding levels would parallel each other. The Rights levels for each year in question could remain stable or change positively or negatively over the years in question.

The same procedures as described above are followed for Round One and Round Two. At the end of Round Two, the forecasting engine performs a number of calculations and produces several charts and tables. For example, a chart for each trend is created that plots the changes in Needs, the changes in Supplies, and the changes in Rights. In addition, the overall (initial year to end year) changes for each Need, Supply and Right are calculated, ranked from highest to lowest, and displayed in a Dynamics Index (DI) (highest to lowest change) table. The Engine also calculates the difference between the Need and Supply values and ranks this difference from highest to lowest in table form. Finally, the difference between the Needs and Supplies for each trend development is calculated and the result is multiplied by the Rights level. The resulting quantities are rank-ordered from highest to lowest in several Action Urgency Index (AUI) tables.

These results are most powerful in assisting a policy analyst. For example, a large difference between the Needs and Supplies multiplied by a small Rights quantity results in a small number and, most probably, a low ranking development requiring action. Compare this to a relatively small difference between a Needs level and a Supplies level multiplied by a large Rights quantity. This would result in a higher number and consequently a high-ranking trend development, indicating a need for more immediate attention or action. This indicator, referred to as an Action Urgency Index (AUI), is calculated for each trend and subsequently ranked from highest to lowest quantities. High-ranking trends suggest imbalances, high dynamics and priorities for action.

While this information is valuable in table form (showing the highest to lowest needs for actions), it is perhaps of greater value in chart form. After the forecasting engine calculates each Needs/Supplies multiplied by Rights level, a value is derived for each year. Plotted in chart form, each trend indicates when it would likely become a problem and the severity of the problem (steepness of the curve). Once depicted and analyzed, this indicates the timeframe and urgency for action. If ignored, such indicators could have costly consequences.

Handling of Event Developments in the Online Delphi

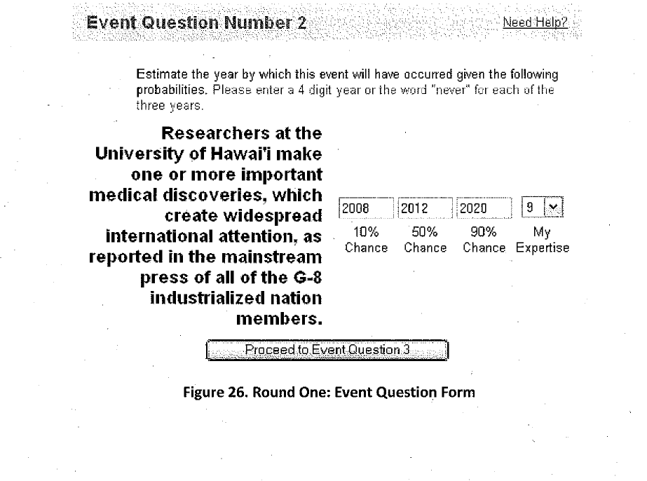

Events are tied to probabilities over time. A specific event is clearly stated as a declaration (usually with a working definition or qualification). The forecasting panelists are asked by which year the event will have occurred with differing probabilities. These probabilities include a slight chance (0.1 or 10%), a moderate chance (0.5 or 50%), and a high chance (0.9 or 90%) that the event will have occurred. An example of the Round One Event Question Form is shown in FIG. 26. Here the panelist estimates by which year there would be a 10% chance that this event would have happened (2008); when there is a 50% chance that it will have occurred (2012); and a 90% chance by which it will have occurred (2020). If the respondent believes the event never has a chance of occurrence, he or she could respond with “never” for any or all probabilities. Due to the possibility of such extreme outliers, the median is employed in the calculations instead of the mean. In the above example, the respondent rated his/her expertise level at nine (9) on a range of 1-10.

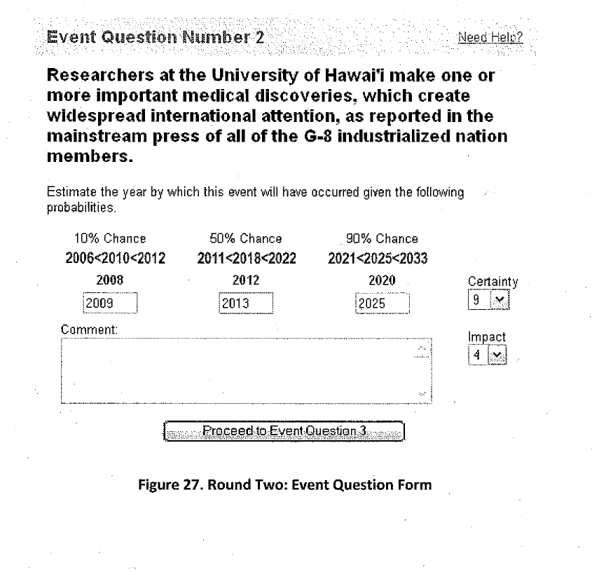

During Round Two (see FIG. 27), the panelist is presented with the results from the previous round, including their own previous estimates. Based on this data, they can choose to change their values or to submit the same estimates as in Round One. This event handling process is the same in both Conventional and Needs/Supplies/Rights Modes.

Stage Four: Report Generation and Interpretation

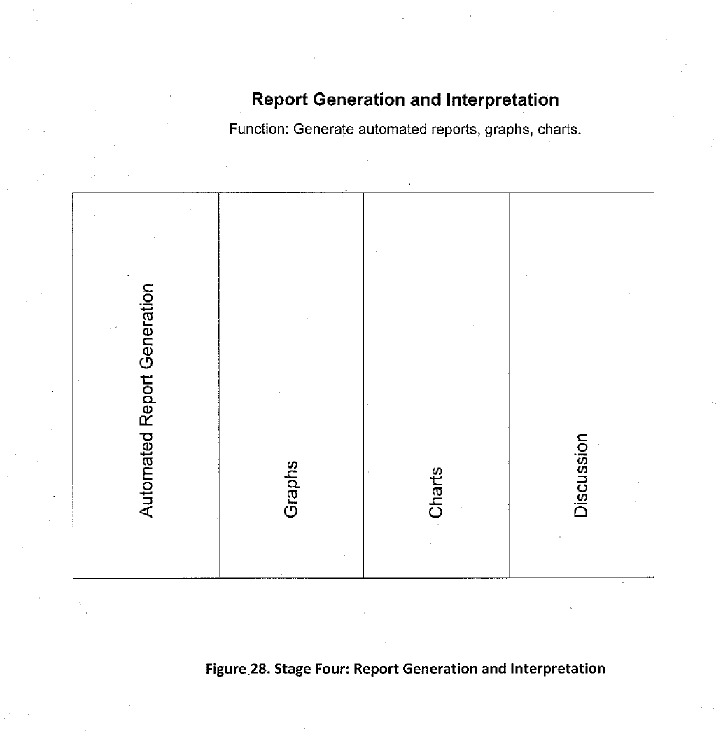

The final stage of the forecasting engine methodology involves sophisticated report generation and interpretation (see FIG. 28). Different calculations are possible for event and trend developments. The events functionality of the forecasting engine allows the user to manipulate the collected data in a number of ways. Specifically, it calculates and sorts by the probability (p) by which an event will have occurred (0.10, 0.50, 0.90). The sort provides the earliest to latest dates for each probability. It also calculates and sorts the percentage change per year (±p) for probabilities ranging from 0.1 to 0.5; calculates and sorts the change per year (±p) for probabilities ranging from 0.5 to 0.9; calculates and sorts by overall change in percentage per year for the range of years in question (the slope or m); calculates and sorts by magnitude of positive/negative Impact (I) of an event if it occurs; calculates and sorts by average Expertise (E, above the established threshold level) for each question; and calculates and sorts by average Certainty (C) level for each question. Finally, the forecasting engine multiplies the average Expertise times Certainty (E*C) levels and sorts high to low, and it multiplies the Impact level of an event occurring times the quantity of Expertise times Certainty (I*E*C) and sorts high to low. There is a link that exports these tables in Microsoft Excel format.

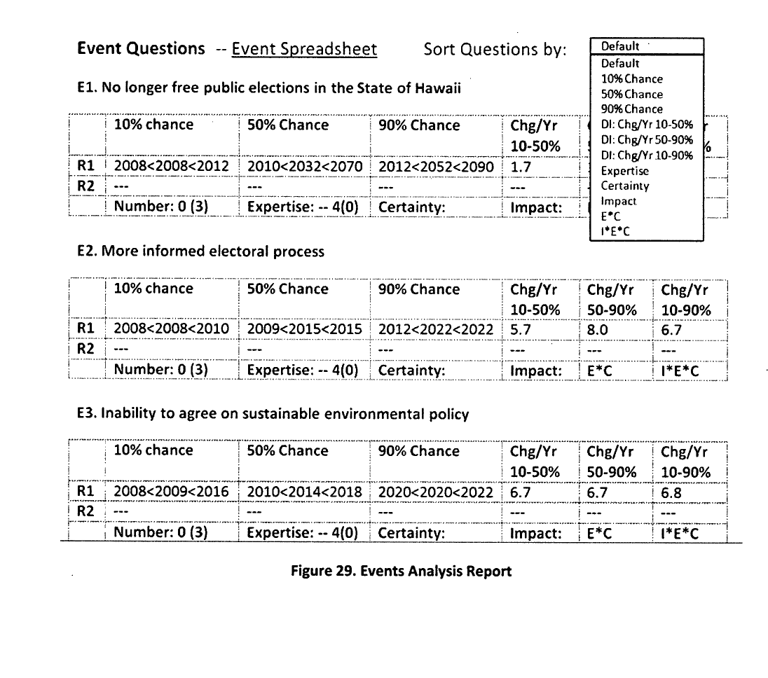

FIG. 29 illustrates a sample Events Analysis Report. The trends functionality of the Futures Forecasting Engine provides some different information than the events results. Rather than concentrating on abrupt or potentially abrupt things happening, trends concentrate on levels of change over time. In Conventional Mode, the trends analysis calculates and sorts the levels of each trend for the years in question (three equally distributed years); calculates and sorts the percentage of change for the first half of the years in question; calculates and sorts the percentage of change for the second half of the years in question; and calculates and sorts the percentage of change from the first year in question until the last year (total change over time). The forecasting engine also sorts by average Expertise (E) levels (above the established threshold level) for each question, and it sorts by average Certainty (C) level for each question. Finally, it multiplies average Expertise times Certainty levels (E*C) and sorts high to low, and multiplies the Impact level of an event occurring times the quantity of Expertise times Certainty (I*E*C) and sorts high to low. There is a link that exports these tables in Microsoft Excel format.

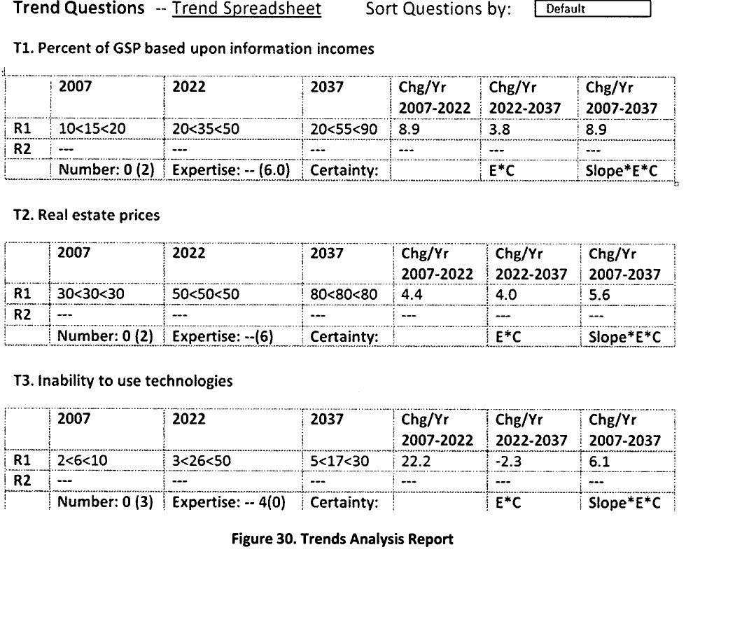

FIG. 30 illustrates a sample Trends Analysis Report. Operating in Needs/Supplies/Rights Mode, the forecasting engine calculates the difference between the Needs and Supply values and ranks this difference from highest to lowest in table form, as well as the overall (initial year to end year) changes for each Need, Supply and Right, ranked from highest to lowest, and displayed in a Dynamics Index (DI) table (indicating highest to lowest change). It also calculates the difference between the Needs and Supplies for each trend development multiplied by the Rights level. This creates an Action Urgency Index (AUI), and the resulting quantities are rank-ordered from highest to lowest in several AUI tables. High-ranking trends suggest imbalances, high dynamics, and priorities for action. The forecasting engine calculates the changes in Needs, the changes in Supplies, and the changes in Rights for each trend and plots them in a chart. Finally, it plots the Needs/Supplies multiplied by Rights value for each year in chart form. Each trend indicates when it will likely become a problem and the severity of the problem (steepness of the curve). Once depicted and analyzed, this indicates the timeframe and urgency for action.

These features make the Needs/Supplies/Rights Mode output particularly useful for long-range planning and policy formation. The Needs/Supplies differences may be most useful in research and development applications.

Several other indicators are available in the final report. The inclusion of several Confidence indicators allows the calculation and sorting of data on a different dimension. It does this by allowing: 1) calculation and sorting of average Expertise (E) for all questions by the specific individual; 2) calculation and sorting of average Certainty (C) for all questions by the specific individual; 3) calculation and sorting of the average Expertise times certainty (E*C) for all questions by the individual; and 4) selection and easily addressed e-mail contact information for subsections or all panelists. This functionality provides a “reverse calibration” in the confidence level of data collected by the forecasting engine.

This feature allows the administrator to establish at what level of Expertise the highest composite Confidence is produced. It calculates: 1) the average Expertise (E) levels (and “Ns”) for all trend and event questions; 2) the average Certainty (C) levels (and “Ns”) for all trend and event questions; and 3) the average Expertise times Certainty (E*C) levels (and number panelists) for all trend and event questions. This also permits optimizing the forecast data (backwards calibration) by manipulation of the threshold level in order to achieve the highest average (E*C) with an acceptable number (n) of panelists.

As discussed previously, the Expertise threshold accessible in the Study Management Rules Form enables the administrator to set minimum levels of expertise for inclusion in results. For example, he or she could limit the included results to those individuals who rated their expertise level on a particular question at “3” or higher (as demonstrated previously in FIG. 8).

Final Output Capabilities

In both Conventional and Needs/Supplies/Rights Modes, the final stage of the Futures Forecasting Engine process is the automated, administrator-assisted, interpretive output stage. Here, the forecasting engine or the administrator decides when to move from the second round of the data collection stage (as prescribed by a percentage rule established at setup time). The forecasting engine shuts itself down (or the administrator can override the forecasting engine and shut it down) and does all of the median and range calculations and graphs for all trends and all events, etc. Throughout the entire forecasting engine process all data is delineated and captured for subsequent analysis and appropriate chart generation.

At the conclusion of the study, a custom backend software program automates final report generation. The final report includes a general introduction; an introduction to event and trend analysis; a summary of notable events and trends that includes prioritization, with relevant charts and graphs; additional calculations and sorting, as desired; and a conclusion. Automation of this customized report saves the administrator substantial time and effort. It also enables exploration and mining of the results, adding substantial value to the forecasting data. This allows for sophisticated analysis of data by a highly informed professional or administrator.

Event Reporting Capabilities

The average Expertise, average Certainty and average Impacts are calculated for all panelists, as are the average overall Expertise for all panelists and for those meeting or exceeding the lowest acceptable level of expertise in the range of 1-10 (e.g. 4/10). The forecasting engine, with the help of the administrator or self-calibration assistance, can set the highest level of Expertise with the highest number of respondent “line of best fit.” The overall study average values of Expertise and Certainty are also calculated and displayed. The edit-enabled, collected comments from each event are also displayed. The events probabilities graphs and tables are reported in 0.10 (10%), 0.5 (50%), and 0.9 (90%) formats.

While these features are automated, the events reporting mode also allows the administrator to add comments to the final report by selecting events from a drop-down list and filling out a comments box. The administrator can also submit a summary interpretation of all event data from the study at the end of the report.

Trend Reporting Capabilities

As in the event reporting capabilities, the average Expertise, average Certainty and average Impacts are calculated for all panelists, as are the average overall expertise for all panelists and for those meeting or exceeding the lowest acceptable level of expertise in the range of 1-10 (e.g. 4/10). The overall study average Expertise and Certainties are also calculated and displayed. The edit-enabled, collected comments from each trend are also displayed. The trend years are dynamic as established by the study administrator at setup time and observed throughout the study (e.g. 2010, 2015, and 2020). As with the events mode, the administrator can add comments to the final report by selecting trends from a drop-down list and filling out a comments box. The administrator can also submit a summary interpretation of all trend data from the study at the end of the report.

Overall Report Generating and Operating Capabilities

The forecasting engine allows for an administrator-generated or automated coversheet and table of contents. All content generation and study summary/recommendations capabilities reported above are available for selection. An integrated, on-line “help function and definition function” will be provided in all necessary areas.

Applications of the Futures Forecasting Engine

Long-range forecasts are, or can be, accurate enough to be relied upon for policy-making, but policy makers do not now rely sufficiently upon such forecasts. While this is true in government, it is also true in industry. Product development is risky and expensive and takes years. Reducing uncertainties has great payoffs. In many cases, longer-term, more holistic supplies and demands must be accounted for in forecasts, alongside event occurrences. Narrow sets of forecasts dictated by the techniques currently employed are not as robust as the projections of a range of top forecasters that can be obtained by the Futures Forecasting Engine. The open architecture of the Futures Forecasting Engine makes it ideal to handle many real-world applications in both government and private sectors. Its automated features harness the power of distributed networks to gather expert data and significantly reduce the effort and time required to conduct a forecasting study.

The forecasting engine is a generic research and forecasting tool that can be used to address a broad range of topics for a wide range of subsequent applications. It will be highly useful in formulating government or non-governmental policies or better-founded strategic plans within any organization of any size. It is also useful in probing opinions (creating data) for short-range or long-range decision making in organizations, local, regional or global.

Within the economic domain, there is a need for a range of techniques that employ state of the art forecasting beyond traditional statistical and mathematical modeling. Traditional economic forecasting (e.g. time series), while useful, draws heavily on past trends and models that often break down in highly turbulent times. Longer range trends and lower probability events are often discounted using traditional economic forecasting techniques. Alternative or combined forecasting approaches offer the possible reduction of single approach procedures and hopefully improve the quality of the forecasts at hand. The Futures Forecasting Engine will find immediate use in areas such as energy and alternative energy planning, business dynamics (e.g. markets), or for managing specific programs such as Medicare or Medicaid.

The forecasting engine also has many applications in the social and cultural domains, including planning for education at all levels, elderly care, and various non-profit organizations.

Within the political domain, the forecasting engine can be used to explore international relations, conflict and peace dynamics, emerging issues/needs assessment, and policies related to science and technology. The Needs/Supplies/Rights Mode is extremely powerful in assisting policy analysis. Prioritization of issues with the Action Urgency Index highlights areas that require more immediate attention. The Futures Forecasting Engine can also be applied to broader-based studies for soliciting the future views of a wide range of a specific population (e.g. labor organizations) or of the general population (e.g. election campaigns).

Technology domain applications of the forecasting engine include biotechnology and medicine, information and communication technologies, and agriculture and food production. Research and development could be made more efficient by identifying and addressing more promising emerging market opportunities, yielding higher profits.

Environmental issues related to demographics and population studies, natural resource allocation, climate forecasts, long-range extinction forecasts, and pollutant management are also well-suited for the forecasting engine.

In summary, due to its flexible nature and automated efficiency, the forecasting engine will find immediate use in a wide variety of applications. Prior to the Futures Forecasting Engine, no generic (non-topic-specific) conventional or automated process has been advanced for the complex and web-based nature of identifying and managing a network of individuals, generating appropriate development questions, prioritizing the questions, collecting and processing focused inputs, and calculating those inputs (along with calibration of Expertise, Impact and Certainty levels of each contributor's estimate).

The Futures Forecasting Engine is substantially more efficient, flexible, and sophisticated than other forecasting processes, promising an immense time and cost savings; and it has many unique, automated features not currently available through conventional or electronic forecasting tools. Automated switching between phases, automated communication processes, and custom report generation will greatly reduce time and capital investment. The forecasting engine's Swarm process is unique in its ability to harness distributed expertise, yielding a diverse set of informed inputs that can be harnessed to address long-term or slowly emerging important problems or opportunities. Further, the forecasting engine is a value-added tool that enables unsurpassed mining and exploration of trend and event developments. The ability to set and modify Expertise thresholds, and to calculate and sort by a number of unique fields (e.g. the product of Expertise, Impact, and Certainty for trend and event developments; the percentage change per year of trend developments) and to automatically produce a variety of tables, charts, and graphs to represent these data is one-of-a-kind. In addition, the Needs/Supplies/Rights Mode, Dynamics Index, and Action Urgency Index are unique and add substantial insight and value.

The forecasting engine, whether used in Conventional or Needs/Supplies/Rights Mode, is a generic research and forecasting tool that can facilitate the creation of data in a broad range of topics for a wide range of subsequent applications. The resulting data will be very useful in formulating industry or government policies or better-founded strategic plans and actions within any organization of any size. It is scalable in time and has an open architecture with regard to topic(s). Because it employs online data collection via the Internet and it is both administrated and automated, it is very time and geographically efficient. This makes it possible for it to be utilized to probe opinions (create data) for short-range or long-range decision making in organizations, whether on a local, regional or global basis. This process and its application add significant value to this data.

Uncertainty increases the demand for information. The more promising the accuracy of the information, the more value it possesses. When high certainty is impossible (e.g. futures research), systematic, sophisticated and administrated/automated inquiry seeks to reduce as much uncertainty as possible. Although potential lack of validity (accuracy) is implicit in futures research, such a condition does not dismiss the need to strive for validity and/or reliability. It is for these reasons that anticipating alternative futures or slowly emerging, longer-range problems or possibilities requires a sophisticated and systematically developed, tested approach, as advanced by the Futures Forecasting Engine.

The necessary approaches and methods are embedded in the inexact sciences (e.g. forecasting, policy making and planning). Precise problem definitions are often impossible, yet advancing descriptions of the problem(s) assists in the selection and the development of appropriate methods or techniques, as set out in the Futures Forecasting Engine. Administration or automated selection of a diverse range of panelists, asking the appropriate questions, and efficient, automated collection, processing, analysis, and reporting of data promise a high return on investment (ROI).

Substantial multi-method research and development in ‘networked forecasting’ has substantial promise and is worth advancing. This is the rationale of the Futures Forecasting Engine development and why an online, web-based, futures forecasting methodology has been developed.

In summary, after years of development an Internet-based Futures Forecasting Engine is now available. It is a tool that promises to contribute significantly to medium and long-range strategic planning and policy formulation. It is a “content creator” which has great potential to reduce uncertainty from the policy and planning process.

It is to be understood that many modifications and variations may be devised given the above description of the principles of the invention. It is intended that all such modifications and variations be considered as within the spirit and scope of this invention, as defined in the following claims.

1. An online futures forecasting method for conducting a study for forecasting future trends and events which employs input from invited participants connected online via a computer network, comprising:
(a) performing a first stage in which a plurality of candidate participants are invited to participate in a futures forecasting study by responding to an invitation message sent to them electronically on the computer network, wherein the futures forecasting engine establishes a subplurality of the participants for the study based on the participants' responses to the invitation message;
(b) performing a second stage in which input on expected future trend and event developments are solicited from participants established for the study by a questionnaire sent to them electronically on the computer network, and then establishing which trends and events meet a threshold to be utilized in the study based on the participants' input;
(c) performing a third stage in which further input of participants' estimates of event probabilities and trend levels over time are gathered from their responses to a further questionnaire sent to them electronically on the computer network, and then calculating rating statistics for the established trends and events based on the participants' further input; and
(d) performing a fourth stage in which the study is completed, all desired rating statistics are calculated, and a final report forecasting future trends and events as rated in the study is prepared.

2. An online futures forecasting method according to claim 1, wherein the stages of a study are performed by a futures forecasting engine programmed in software and accessible by participants in a study via an online browser connected to the computer network.

3. An online futures forecasting method according to claim 2, wherein the futures forecasting engine enables an administrator to establish a new study and its parameters, as well modify or delete an old study.

4. An online futures forecasting method according to claim 2, wherein in the first stage the administrator selects a threshold number of desired participants to whom an invitation message is sent inviting participation in the study, and the first stage is terminated and the second E stage initiated once the threshold number is met by responses of invited participants.

5. An online futures forecasting method according to claim 2, wherein, in an Alpha phase of the second stage, participants' input are solicited to create data representing trends and events developments to be analyzed by the futures forecasting engine, and in a Beta phase of the second stage, the futures forecasting engine categorizes and assists prioritization of the data on trends and events development based on parameters established for the study.

6. An online futures forecasting method according to claim 2, wherein, in a Round One of the third stage, the futures forecasting engine sends a questionnaire on trends and events established in the second stage of the study to each participant, including a request to estimate his/her level of expertise on a given rating scale.

7. An online futures forecasting method according to claim 6, wherein, in Round One of the third stage, the questionnaire further includes a request to estimate trend levels and forecast event probabilities for forecast years.

8. An online futures forecasting method according to claim 7, wherein, after the Round One data are collected, the futures forecasting engine automatically calculates one or more calculations of the group consisting of: (1) average Certainty (C) of each forecast; (2) average Expertise (E) level for each forecast; (3) average Impact (I) of each event if it is to occur; (4) Expertise level of the panelists multiplied by the Certainty level (i.e. E*C) for each event and each trend; and (5) Impact of each event if it is to occur multiplied by the Expertise level and the Certainty level (i.e. I*E*C).

9. An online futures forecasting method according to claim 7, wherein, in a Round Two of the third stage, the futures forecasting engine sends a further questionnaire to each participant requesting a refined estimate within the rated ranges for trend levels and event probabilities.

10. An online futures forecasting method according to claim 9, wherein, after the Round Two data are collected, the futures forecasting engine automatically calculates one or more calculations of the group consisting of: (1) rates of change in probabilities of event occurrences; (2) average percentage change per year; (3) a summary of years when there is a slight, moderate, and strong probability that each event will occur; and (4) calculation of specific levels of each trend development and the percentage change per year.

11. An online futures forecasting method according to claim 2, wherein, in the fourth stage, the futures forecasting engine calculates one or more calculations of the group consisting of: (1) Event List sort; (2) Trend List sort; (3) Individual Confidence/Expertise level sort; and (4) Composite Confidence/Expertise level calculation.

12. An online futures forecasting method according to claim 2, wherein, in the fourth stage, the administrator can sort each trend or event by one or more calculations of the group consisting of: (1) highest certainty (C); (2) highest Expertise times Certainty (E*C); and (3) highest Impact times Expertise times Certainty (I*E*C).

13. An online futures forecasting method according to claim 9, wherein the futures forecasting engine allows the administrator to select between two different modes for handling trends data in the study: Conventional Mode and Needs/Supplies/Rights Mode.

14. An online futures forecasting method according to claim 13, wherein in Conventional Mode, participants in Round One of the third stage are asked to estimate a trend level in specified years in the future, and in Round Two, the participants are provided with a summary of the Round One ratings, and asked to choose to change values for the specified years or to keep the same values they estimated in Round One.

15. An online futures forecasting method according to claim 13, wherein, in the Needs/Supplies/Rights Mode, each trend is broken out into three dimensions: Needs (for), Supplies (of), and Rights (to) a particular development, and each of these dimensions is further separated into a number of time frames, and participants in Round One of the third stage are asked to estimate a trend level for each of the dimensions and time frames and to set benchmark levels for them and estimate how they may vary over the time frames.

16. An online futures forecasting method according to claim 15, wherein, after Round Two, the forecasting engine performs one or more calculations, charts and tables of the group consisting of: (1) chart for each trend that plots changes in Needs, changes in Supplies, and changes in Rights; (2) overall (initial year to end year) changes for each Need, Supply and Right, ranked from highest to lowest, and displayed in a Dynamics Index (DI) (highest to lowest change) table; (3) difference between the Need and Supply values and ranks this difference from highest to lowest in table form; and (4) difference between the Needs and Supplies for each trend development multiplied by the Rights level, which are rank-ordered from highest to lowest in Action Urgency Index (AUI) tables.

17. An online futures forecasting method according to claim 9, wherein the futures forecasting engine allows the administrator to select between two different modes for handling events data in the study: Conventional Mode and Needs/Supplies/Rights Mode.

18. An online futures forecasting method according to claim 17, wherein in Conventional Mode, participants in Round One of the third stage are asked to estimate by which year an event will have occurred with differing ranges of probabilities, and in Round Two are asked to choose to change their values or to submit the same estimates as in Round One.

19. An online futures forecasting method according to claim 1, wherein, in the fourth stage, the final report may include one or more of the group consisting of: (1) calculation and sorting of average Expertise (E) for all questions by the specific individual; (2) calculation and sorting of average Certainty (C) for all questions by the specific individual; (3) calculation and sorting of the average Expertise times certainty (E*C) for all questions by the individual; (4) selection and easily addressed e-mail contact information for subsections or all participants; (5) average Expertise (E) levels for all trend and event questions; (6) average Certainty (C) levels for all trend and event questions; and (7) average Expertise times Certainty (E*C) levels for all trend and event questions.

20. An online futures forecasting method according to claim 1, wherein said method is applied to one or more applications of the group consisting of: (1) long-range forecasts for policy-making; (2) product development forecasts; (3) strategic planning; (4) short-range or long-range decision making in organizations; (5) economic forecasting; (6) energy and alternative energy planning; (7) dynamics of markets; (8) management of institutional programs such as Medicare or Medicaid; (9) social and cultural planning; (10) international relations, conflict and peace dynamics; (11) emerging issues/needs assessment; (12) policies related to science and technology; and (13) environmental forecasting.
